(19) United States
(12) Patent Application Publication
(10) Pub. No.: US 2007/0261159 A1
(43) Pub. Date: Nov. 15, 2007

(54) Utility container suspended from toilet paper dispenser

(76) Inventor: Ronald A. Marks, Bakersfield, CA (US)

Correspondence Address: James M. Duncan;Klein, DeNatale, Goldner, Cooper,, Rosenlieb & Kimball, LLP, P.O. Box 11172, Bakersfield, CA, 93389-1172, US

(21) Appl. No.: 11/494,437

(22) Filed: Jul. 26, 2006

Related U.S. Application Data
(60) Provisional application No. 60/799,829, filed on May 11, 2006.

(51) Int. Cl. A61G 7/02; A47K 11/06

(52) U.S. Cl. 4/480

(57) ABSTRACT

A utility container which is suspended from a toilet paper dispenser comprises a box member having a left side panel, a right side panel, a front side panel, a back side panel, and a bottom panel. The box member is suspended from the spindle of the dispenser by a pair of J-shaped hanger members which are integral to the side panels. When installed, the toilet paper roll is disposed between the pair of hanger members. An alternative embodiment of the utility container comprises a dispensing member through which the user may obtain cleanser or lotion as desired.

### BACKGROUND OF THE INVENTION

The present invention generally relates to vanity and toiletry cabinets and storage containers. It more specifically relates to containers which are in the proximate location of restroom facilities such as toilets and bidets. It is known to place shelving or other storage devices within arm's length of a toilet to allow the user easy access to additional toilet tissue, facial issue, cleaning wipes, lotions, etc. as desired. The known devices often require separate attachment to an adjacent wall or comprise bulky free-standing shelving units. The disclosed invention provides a convenient and easily installed alternative to the known devices.

### SUMMARY OF THE INVENTION

The embodiments of the apparatus disclosed herein meets the need discussed above. The apparatus comprises a utility container which is used in combination with a toilet paper dispenser, the toilet paper dispenser being of the type in which the toilet paper roll is disposed on a spindle, where the spindle is disposed between a pair of bracket members which extend from a mounting surface. The utility container comprises a box member having a left side panel, a right side panel, a front side panel, a back side panel, and a bottom panel. The box member is suspended from the spindle of the dispenser by a pair of J-shaped hanger members which are integral to the side panels. When installed, the toilet paper roll is disposed between the pair of hanger members.

### BRIEF DESCRIPTION OF THE DRAWINGS

FIG. 1 shows a perspective view of an embodiment of the utility container as attached to a toilet paper dispenser.

FIG. 2 shows a front view of the embodiment of the device shown in FIG. 1.

FIG. 3 shows a side view of the embodiment of the device shown in FIG. 1.

FIG. 4 shows a top view of the embodiment of the device shown in FIG. 1.

FIG. 5 shows a bottom view of the embodiment of the device shown in FIG. 1.

FIG. 6 shows a perspective view of an alternative embodiment of the utility container as attached to a toilet paper dispenser.

### DETAILED DESCRIPTION OF THE EMBODIMENTS

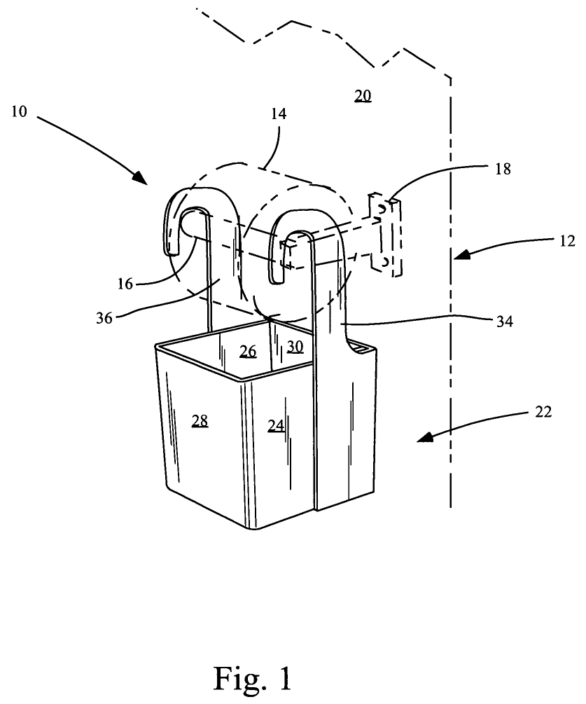

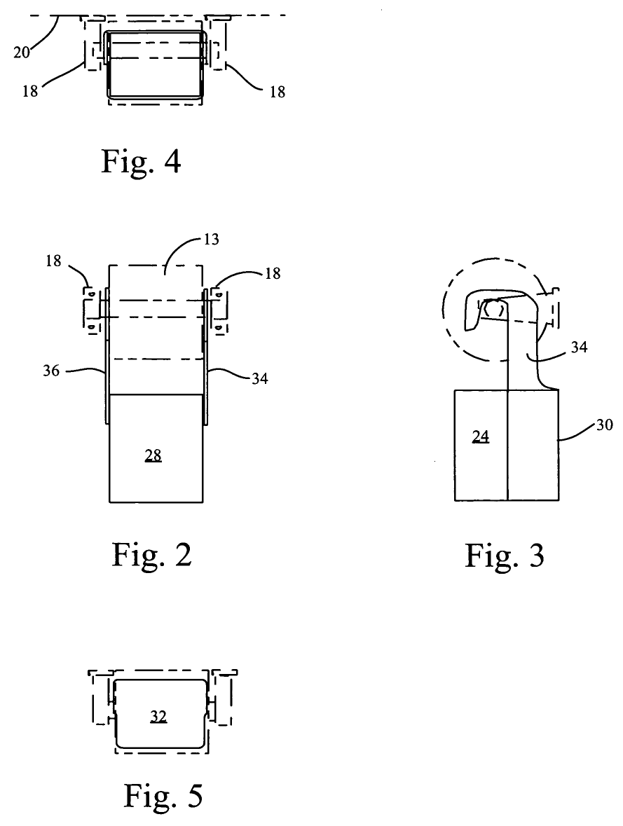

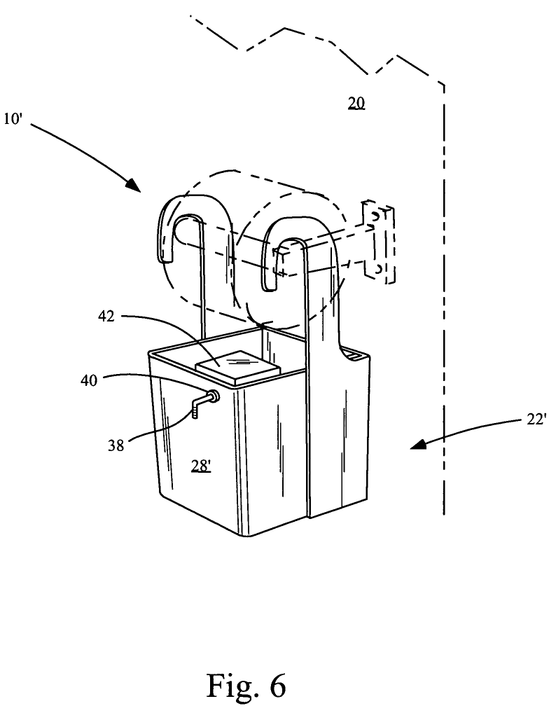

Referring now specifically to the drawings, FIG. 1 shows the utility container 10 suspended from a toilet paper dispenser 12. As shown in FIG. 1, the toilet paper dispenser is of the type in which a toilet paper roll 14 is disposed on a spindle 16. As known, the spindle 16 is typically spring-loaded such that when disposed between a pair of bracket members 18. The bracket members 18 extending from a mounting surface 20.

The utility container 10 comprises a box member 22. The box member 22 comprises a left side panel 24, a right side panel 26, a front side panel 28, a back side panel 30, and a bottom panel 32. The utility container 10 may be manufactured from a variety of materials, such as injection-molded plastic.

The left side panel 24 comprises an integral J-shaped left side hanger member 34. Likewise, the right side panel 26 comprises an integral J-shaped right side hanger member 36. As shown in FIG. 1, the left side hanger member 34 and the right side hanger member 36 are adapted to be suspended from the spindle 16 with the toilet paper roll 14 disposed between the left side hanger member and the right side hanger member.

In an alternative embodiment 10′ of the device, a modified box member 22′ may be utilized, wherein modified such that a dispensing member 38 protrudes from a port 40 in front side panel 28′. In this embodiment, a container 42 holding cleanser or lotion may be disposed within the box member 22′ and connected to the dispenser member 38. A user may then have convenient access to the cleanser or lotion.

While the above is a description of various embodiments of the present invention, further modifications may be employed without departing from the spirit and scope of the present invention. For example, the size, shape, and/or material of the various components may be changed as desired. Thus the scope of the invention should not be limited by the specific structures disclosed. Instead the true scope of the invention should be determined by the following claims.

What is claimed is:

1. A utility container used in combination with a toilet paper dispenser, the toilet paper dispenser being the type wherein a toilet paper roll is disposed on a spindle, the spindle being disposed between a pair of bracket members, the bracket members extending from a mounting surface, the utility container comprising:
a box member comprising a left side panel, a right side panel, a front side panel, a back side panel, and a bottom panel, wherein the left side panel comprises an integral J-shaped hanger member and the right side panel comprises an integral J-shaped hanger member, wherein the left side hanger member and the right side hanger member are adapted to be suspended from the spindle with the toilet paper roll disposed between the left side hanger member and the right side hanger member.

2. The utility container of claim 1 further wherein the front side panel comprise a port and a dispensing member extends through the port from the inside of the box member to the exterior of the box member.

3. A utility container used in combination with a toilet paper dispenser, the toilet paper dispenser being the type wherein a toilet paper roll is disposed on a spindle, the spindle being disposed between a pair of bracket members, the bracket members extending from a mounting surface, the utility container comprising:
a box member comprising a left side panel, a right side panel, a front side panel, a back side panel, and a bottom panel, wherein the front side panel comprises a port and a dispensing member extends through the port from the inside of the box member to the exterior of the box member, and wherein the left side panel comprises an integral J-shaped hanger member and the right side panel comprises an integral J-shaped hanger member, wherein the left side hanger member and the right side hanger member are adapted to be suspended from the spindle with the toilet paper roll disposed between the left side hanger member and the right side hanger member.
